(19) United States
(12) Patent Application Publication
(10) Pub. No.: US 2009/0299791 A1
(43) Pub. Date: Dec. 3, 2009

(54) Method and system for management of licenses

(75) Inventors: Victor R. Blake, Lincoln, VA (US); Ritesh Rekhi, San Jose, CA (US)

Correspondence Address: SCHWABE, WILLIAMSON & WYATT P.C., 1420 5TH AVENUE, SUITE 3010, SEATTLE, WA, 98101, US

(73) Assignee: Foundry Networks, Inc., Alviso, CA (US)

(21) Appl. No.: 10/606,545

(22) Filed: Jun. 25, 2003

(51) Int. Cl. G06Q 10/00; G06Q 50/00; G06F 15/16; G06F 15/173

(52) U.S. Cl. 705/8; 705/30; 726/3; 709/225

(57) ABSTRACT

Licensed connections to network resources or services, such as servers or applications, are managed, including setting, limiting, monitoring, enforcing, recording, reporting, or otherwise managing licenses across multiple network resources. Real-time information that tracks license usage is logged. Reporting features are provided to allow a system administrator, vendor, network operator, or other entity to access the log information to determine license usage and compliance. Layer 7 information is used for determining distribution of licensed connections, including an implementation where connection to mail servers is distributed according to username. License management may be performed with or without using load-balancing technology.

### BACKGROUND OF THE INVENTION

1. Field of the Invention

This disclosure relates generally to management of resources in a communication network. More particularly but not exclusively, the present disclosure relates to techniques to manage user or software licenses in a network, as well as management of other resources, such as mail.

2. Description of the Related Art

An enterprise (such as a business, network operator, or other organization) typically purchases software or application licenses for its users. For example, user licenses can be purchased for using certain software applications, servers, services, and other network resources. These licenses provide the enterprise with permission to use the licensed product so long as the enterprise complies with the conditions of the license agreements, which themselves usually vary in terms of provisions, limitations, or other conditions.

As one example, an enterprise can obtain licenses to allow its users to access and use a standard query language (SQL) server. The users connect to the SQL server through a network and a switch, with the SQL server being connected to a local database that has the license information for that enterprise. Assuming that the enterprise has purchased 50 user licenses for purposes of explanation, then user1-user50 can connect to the SQL server at any one time. To confirm compliance with licensing conditions, the SQL server checks the local database to verify the number of usernames and/or number of current sessions N. If N≦50, then the SQL server instructs the switch to complete the connection.

However, if there are more than 50 users (i.e., N>50) that attempt to connect to the SQL server, then the switch will deny access to users that exceed the 50-license limit. The excess users will generally not know why they were denied access, and instead are generally notified of an inaccessible server via some type of message. From a manual perspective, system administrators for the SQL server will typically be made aware of the condition if they monitor a console for that particular SQL server or if they monitor some other type of remote monitor application (such as a web or Windows-based application).

Meanwhile, the enterprise network and/or its network operators at the user end are totally unaware of what has happened. For example, the user51 may attempt a connection to the SQL server 5 times and fail. The user51 calls a help desk and complains. Because the network operator for the enterprise has no visibility into the licensing conditions of the SQL server, the user51's problem is viewed as a “connectivity issue of a network” and is incorrectly pursued as one, thereby wasting a great deal of time and effort checking and verifying the accessibility of the SQL server (such as via “pinging” the SQL server).

There are also problems from the point of view of a system administrator of the SQL server. Suppose, for instance, that the switch is connected to multiple SQL servers. The system administrator may be watching the console for one of the SQL servers, and therefore does not know what may be transpiring at the other SQL servers—the system administrator cannot watch that many consoles simultaneously. Moreover, the system administrator will generally not know which SQL server that the user51 attempted to access, particularly if the SQL servers are load-balanced based on standard criteria (e.g., round robin, weighted round robin, connection load balancing, traffic volume, etc.).

Analogous problems are encountered with electronic mail systems, such as those based on Post Office Protocol (POP). In one example architecture, POP mail is distributed across multiple POP mail servers to reduce the processing load on what would otherwise be a single large POP mail server. However, if the number of users on any single POP mail server exceeds its licensing conditions or is otherwise inundated beyond capacity, then the excess traffic is routed to other POP mail servers, assuming that those POP mail servers have back-end databases that have data files corresponding to the re-routed users—otherwise, these excess users would have to wait until their specific POP mail servers become available. Therefore, this is a cumbersome and inefficient system in many ways.

### BRIEF SUMMARY OF THE INVENTION

One aspect of the present invention provides a method that sets license parameters associated with at least one network resource, including use of load-balancing criteria in conjunction with the license parameters. A request to access the network resource is received, and the method determines if the license parameters will permit the requested access to the network resource. The method grants the requested access to the network resource if it is determined that the license parameters permit the requested access to the network resource and provides access based at least in part on the load-balancing criteria.

### BRIEF DESCRIPTION OF THE SEVERAL VIEWS OF THE DRAWINGS

Non-limiting and non-exhaustive embodiments of the present invention are described with reference to the following figures, wherein like reference numerals refer to like parts throughout the various views unless otherwise specified.

FIG. 1 shows a system in accordance with an embodiment of the invention.

FIGS. 2A and 2B illustrate a flowchart depicting operation of an embodiment of the invention in accordance with the system of FIG. 1.

FIG. 3 illustrates example systems that may be used to remotely manage licenses in accordance with an embodiment of the invention.

FIG. 4 illustrates an example hierarchical license management system in accordance with an embodiment of the invention.

FIG. 5 is a diagram that symbolically depicts organization of licenses in accordance with an embodiment of the invention.

FIG. 6 shows a system to balance mail in accordance with an embodiment of the invention.

FIG. 7 diagrammatically illustrates operation of the mail balancing in accordance with an embodiment of the invention.

FIG. 8 shows a system in accordance with another embodiment of the invention.

### DETAILED DESCRIPTION

Embodiments of techniques to manage licenses are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, one embodiment of the invention uses load-balancing techniques to manage user license connections. For example, principles of load-balancing techniques, including those that familiar to persons skilled in the art (including global server load balancing technology for Serverlron™ products that are available from Foundry Networks, Inc. of San Jose, Calif.), are used to manage users connected to a service for purposes of setting, limiting, monitoring, enforcing, recording, reporting, or otherwise managing licenses across multiple servers, applications, services, or other network resources, as compared to use of such load-balancing techniques for their traditional purposes. In one embodiment, user connections are maximized by using layer 7 information to distribute users across servers in order to reduce the maximum number of user licenses that are paid for by the network operator (or other entity), thereby maximizing the number of usable licenses and minimizing software/hardware licensing costs.

License management can be performed in conjunction with local load balancing (e.g., the load balancing can be performed in the same “box” or in the same license management system. In another embodiment, license management may be performed remotely from, independent of, and separated from any load balancing, where the license management system does not need to be aware of the load balancing. In yet another embodiment, license management may be performed without any sort of load balancing being present.

One embodiment of the invention relates to content-based management of connections in TCP/IP and Internet (hereinafter referred to as “IP” for convenience) data communications. An apparatus (such as one or more switches or routers), incorporated into a computer system or a network device, allows management of the quantity of connections from client devices (computers, cell phones, PDAs, or Internet-enabled devices) to application services (such as email, databases, web applications, games, or other network resources) on the basis of criteria related to licensing conditions. Such criteria include, but are not limited to, identification of which servers support certain applications (including version types), minimum and maximum users (specified on a per server, per application, per geography, per source or destination, or other factors), layer 3 to layer 7 information, number of connections, user names, and others. Other criteria usable for managing licensed connections can include enterprise-wide criteria, location, workgroup, project, vendor of the service, target operating system, or other organizational criteria.

An embodiment of the invention provides a method to manage either or both the total number of connections and sessions, or clients, on a single destination system or across any arbitrary set of systems in order to provide a systematic and reliable method of controlling, limiting, monitoring, recording, etc. the use of software licenses for applications. Various embodiments include methods that can be deployed on a computer or network apparatus that: (1) sets various limits including threshold warning and rejection limits; (2) manages the distribution of total limits as in (1) across one or more destination systems on a single computer or network apparatus; (3) extends the setting of limits and controls across two or more computers or other network apparatus; (4) records, stores, logs, and retrieves the time, location, source, destination, application name or designation, and current distribution of connections, sessions, or clients; (5) directs the information in (4) to other computer systems or apparatus of choice; (6) defines services by any combination of: (a) IP source address, (b) IP destination address or target, (c) source port, (d) destination port, (e) deep packet (layer 7) content including URLs, XML content, username, etc., and (e time of day at source or destination; or (7) collects, organizes, and reports the license management information for the purpose of controlling, limiting, managing, and auditing compliance with software or application licenses.

Additional embodiments of the invention provide balancing for mail, such as POP mail. Session-based and username information (e.g., layer 5 to layer 7 information) is used in addition to port-based mapping information (e.g., layer 4 information) to load balance POP mail users across POP mail servers. For example, usernames from letters A-E are assigned to a first POP mail server, usernames from letters F-J are assigned to second POP mail server, usernames from letters K-O are assigned to a third POP mail server, and so on. In another embodiment, a type of POP username “home geo-balancing” is provided, where the distribution of Users to POP mail servers is done physically or electronically near to their “home” network location. To make up for a potential single point of failure, traditional server load-balancing mechanisms (which would be familiar to those skilled in the art) can be used to distribute users assigned to a single server (which in this case now becomes a cluster).

As an initial consideration to a id in understanding the operation of various embodiments of the invention, a discussion of network communications and load balancing is first provided herein: Existing technologies allow network operators to manage the load of clients across a number of servers in order to distribute the processing load across networks and servers. The benefits of these technologies include traffic management, processor management, reduced cost (compared to larger monolithic systems), and increased reliability. These systems use load-balancing technologies and methods like round robin, weighted round robin, server health and least connections to determine and manage the connection of clients to available servers. Current systems and devices allow for both local and distributed load balancing through the use of either transparent redirection or application redirection. In practice, these systems are used for traffic management, performance optimization, increased reliability, and the like. Example techniques for load balancing based on performance metrics are disclosed in U.S. application Ser. No. 09/670,487, entitled “GLOBAL SERVER LOAD BALANCING,” filed Sep. 26, 2000 and in this application's related co-pending applications, assigned to the same assignee as the present application, and which are incorporated herein by reference in their entirety. These technologies are available in stand-alone devices, integrated into network devices such as switches and routers, and as distributed software running on either or both of client and server systems.

The most basic unit of data transmission in TCP/IP or Internet networking is a “packet.” This is a small piece of information coded at a source, marked with the source address (SA) and directed to a destination address (DA). Traditional IP networks and systems rely exclusively on IP addressing to “route” the packet from one IP network to another until arriving at the destination address specified in the packet. Switches and hubs (such as Ethernet switches) forward packets as a collection of smaller units called “frames.” These switches use a separate system of MAC addresses and the Address Resolution Protocol (ARP) to match the MAC address of a network interface card or port on a network device to its assigned IP address. This is because MAC addresses are in most cases hard coded to the hardware (electronics) and IP addresses can be assigned and changed. The network devices that route IP packets are called “routers.” The network devices that route each individual frame comprising packets are called “switches.” A simpler device that broadcasts all frames to every station regardless of address is called a “hub” or “concentrator.” Some Ethernet systems that function across a single wire without a hub also exist as with 10Base-2 and 10Base-5, otherwise known as “Thin-Wire Ethernet” and “Thick-Wire Ethernet,” respectively.

In addition to MAC and IP addressing, IP systems developed a subset of addressing to allow computer systems to communicate from one application on one system to an application on another separate system. This is a system of port addressing. This system works somewhat like a telephone extension by directly connection the caller (the client) to the correct extension (the application) on the destination server. Since most IP devices (PC computers, servers, cell phones, PDAs, etc.) can now serve or run applications, the distinction of client and server is useful only with respect to identifying which system initiated a connection. So, a client is like a “caller” in a telephone system.

A common system of so-called “well-known” (see, e.g., Internet Assigned Numbers Authority or IANA) ports has evolved to simplify the development of applications and services across vendors' products. This system identifies ports that are used for specific applications. So, for example, listed below are some common and well-known ports:

| Application | Acronym | Port # |
|---|---|---|
| File Transfer Protocol | FTP | 21 |
| Secure Shell | SSH | 22 |
| Telnet | | 23 |
| Simple Mail Transfer Protocol | SMTP | 25 |
| Domain Name Server | DNS | 53 |
| Trivial FTP | TFTP | 69 |
| Hyper Text Transfer Protocol | HTTP | 80 |
| Post Office Protocol version 2 | POP2 | 109 |
| Post Office Protocol version 3 | POP3 | 110 |
| Standard Query Language Server | SQLSERV | 118 |
| Network News Transfer Protocol | NNTP | 123 |
| SQL Net | SQLNET | 150 |
| SQL Server | SQLSRV | 156 |

There are currently 65,535 available ports in the addressing system. Some are standardized and assigned, others are registered, some “commonly” used, and others just used indiscriminately by application developers. Ranges of addresses are specified for each of the above possible types of use to minimize unintentional cross-use of ports.

Methods (embodied in software on computer systems or in the apparatus of a network device such as a router or switch) exist that read the contents of the IP packet (beyond the MAC address and IP address) and use that information for switching decisions. Methods and apparatus also exist to provide a virtual IP address to act in place of (or proxy) for a service, thereby allowing the system or apparatus to balance or direct traffic to a destination that is transparent or invisible to the client.

All of these systems were implemented to solve problems of balancing and directing the loads of networks, computers, storage systems, and other data communications and processing apparatus. Load-balancing systems implement methods to achieve distribution based on either performance or some corollary for performance such as connection counts, etc.

Load-balancing technologies distribute the central processing unit (CPU) processing load across multiple servers, and distribute the accompanying network traffic across multiple LAN segments, such as across subnets. Moreover, load-balancing technologies increase system reliability by reducing the mean time to recovery (MTTR) through stateful failover techniques; reducing MTTR by monitoring (and in some cases proactively testing) server and application responsiveness and performance (and replacing or removing failed servers or applications automatically); increasing mean time between failures (MTBF) by increasing the number of backup components; increasing MTBF by distributing the same load across a greater number of servers and thereby reduce the probability of a failure affecting any one connection; and monitoring and limiting the number of connections per server to prevent failure or reduced performance caused by overloading a server or application.

Load-balancing methods user the following information to distribute connections across servers: source address (SA), source port (SP), destination address (DA), and destination port (DP). In addition, some systems (like those provided by Foundry Networks, Inc. of San Jose, Calif.) use URLs for parsing and load balancing. An example is:

1. For a given SA:SP pair, and

2. For a given DA:DP pair,

3. Map the SA packet from DA (the VIP on the switch) to a real address (RA),

4. For the duration of a session (from SYN to FIN).

Exceptions include the ability to re-map from one RA (e.g., from RA1 to RA2) to move the connection in the event of a failure at RA1 (by not responding to an application check or by timeout, etc.). Foundry Networks' products support these capabilities, plus the ability to mirror state across switches for improved reliability. Load balancing across switches is also supported via forms of global server load balancing (GSLB), such as disclosed in the previously filed applications identified above. These additional capabilities can use IP information (such as BGP routing tables) in combination with SA:SP and DA:DP pairs to manage switch connections and sessions.

One embodiment of the invention addresses a need to limit the number of connections to a system based not on performance or balancing criteria (as would be the basis of traditional load-balancing technology), but instead on other policy criteria. In particular, one embodiment manages the total number of connections across an open distributed system and to individual systems to which an apparatus directs connections, based on the permissible licenses that the operator of the network or system has purchased or paid for and has legal license to use.

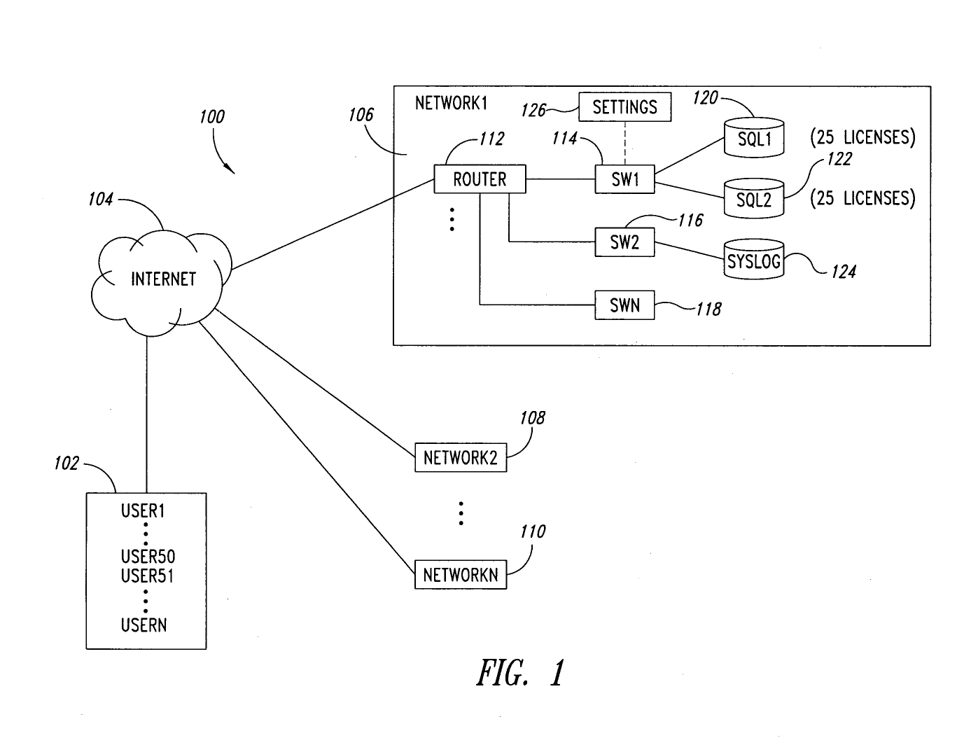

FIG. 1 shows a system 100 in accordance with an embodiment of the invention. For purposes of simplicity of explanation, not all of the various devices that may be present in the system 100 (such as DNS servers, hubs, switches, routers, and so on) are shown or described.

The system 100 includes a plurality of users 102, which can include any sort of suitable user-side client devices. The users 102 comprise users1-userN. The users 102 are communicatively coupled to a communication network 104, which can comprise the Internet, an intranet, Local Area Network (LAN), Virtual LAN (VLAN), Virtual Private Network (VPN), Metro network, Wide Area Network (WAN), or other network or portion or combination thereof. For purposes of explanation, the communication network 104 will be described in the context of the Internet herein.

Via the communication network 104, the users 102 can communicate with different networks 106 (Network1), 108 (Network2), through 110 (NetworkN). These individual networks can comprise web sites, VPNs, LANs, Metro networks, WANs, server clusters, or other type of network arrangement. In an embodiment, each of the networks 106-110 or any of their internal components can be assigned with real or virtual IP (VIP) addresses.

The network 106 comprises one or more routers 112. One or more switches 114 (SW1), 116 (SW2), through 118 (SWN) are coupled to the router 112. In an embodiment, a plurality of servers 120 and 122 are coupled to any one of the switches 114-118. For purposes of illustration, the servers 120 and 122 are shown as SQL1 and SQL2 servers, respectively, that are coupled to the SW1 switch 114. It is understood that other types of services (or combinations or multiples thereof may be available through the switches 114-118, including applications, email, and so on.

It is assumed for purposes of explaining an embodiment of the invention that 25 user licenses are available for each of the servers 120 and 122. The number of licenses can vary from one server to another and may be allocated in other ways to best optimize the number of license connections that can be supported in accordance with an embodiment of the invention.

In an embodiment, one or more of the switches 114-118 can include a data repository 124 to store data related to tracking licensed user connections. As one example implementation, the data repository 124 can comprise a syslog server that is accessible by a licensor and which can be checked as needed to verify license compliance. The data repository 124 can be present at each of the switches 114-118. According to various embodiments, a dedicated syslog facility can be deployed to aggregate licensing logs to one central or multiple location(s). The licensing information can also be logged to an aggregate syslog facility, thereby making it easier to correlate events. In turn, systems management software can be used to perform the correlation.

The other networks 108-110 can include components similar to those of the network 106. For the sake of brevity and simplicity, such components are not repeatedly shown and described herein for networks 108-110. License management according to an embodiment of the invention may be performed across multiple applications, servers, and networks.

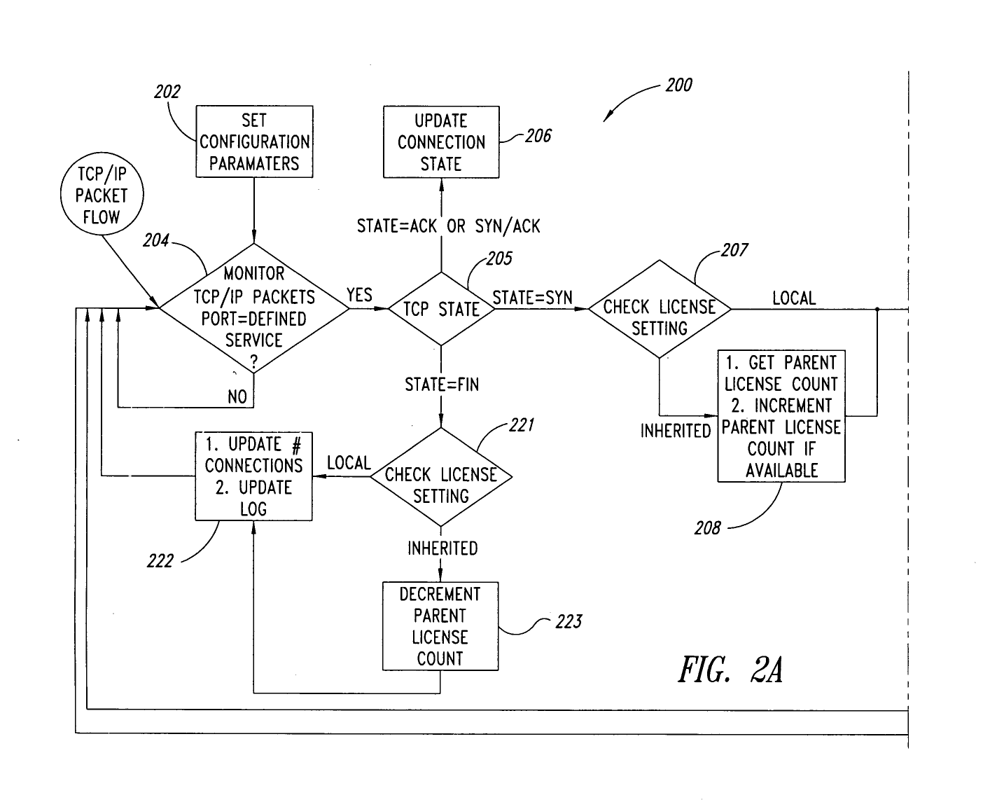

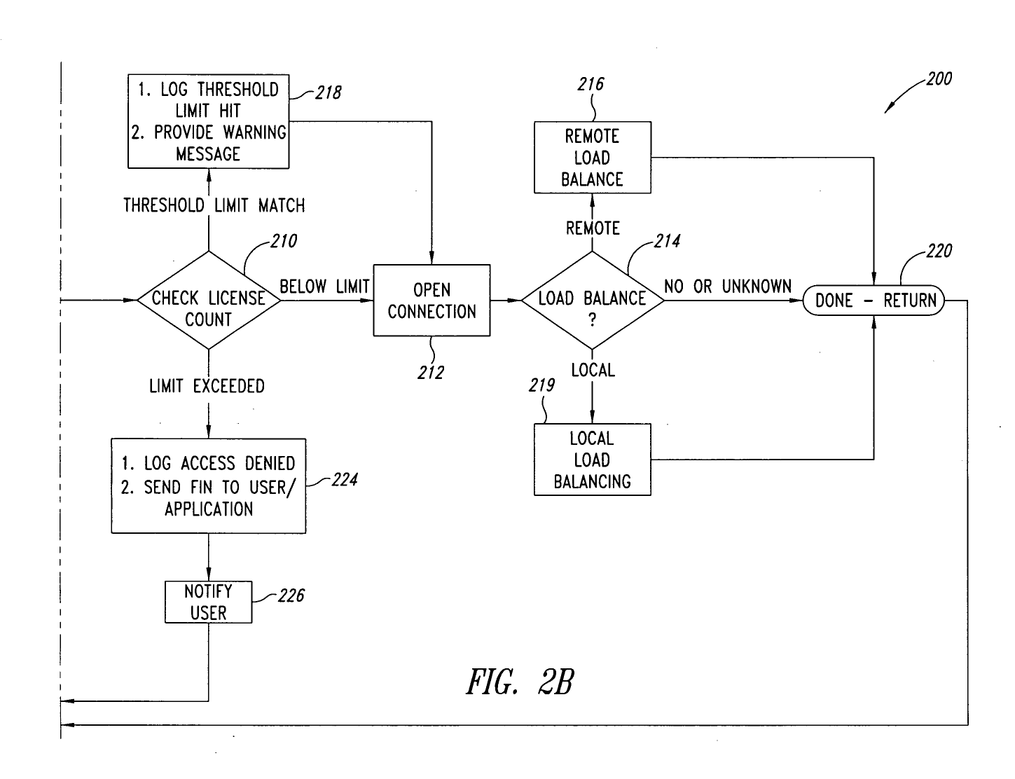

FIGS. 2A and 2B illustrate a flowchart 200 that depicts operation of an embodiment of the invention in accordance with the system 100 of FIG. 1, using an example scenario to help explain the operation. It is understood that the operations depicted in the flowchart are not limited solely to the system 100, and may be implemented in the other systems described herein or in other suitable systems. The various components underlying the operations depicted in the flowchart 200 can be implemented in software or other machine-readable instruction stored on a machine-readable storage medium. Such software can be present in the switch(es) 114-118 or other network component(s) in one embodiment. It is understood that the various operations in the flowchart 200 need not necessarily occur in the exact order shown, and that various operations can be combined, added, or removed.

Certain configuration parameters or settings are made at a block 202, which may be done at the switches 114-118 in one embodiment. The types of settings that can be specified include:

1. Define virtual IP (VIP) address(es) to act as proxies for each service;

2. Define services (by well-known name or port number, for example). Additionally, define services (e.g., sqlsrv for SQL applications) and other layer 7 information identified elsewhere herein;

3. Define real servers supporting each defined service; and

4. Set limits for:
a. Total licenses permitted for each service (locally with an integer number or “inherited” with a defined parent to automatically inherit from a parent);
b. Total licenses (maximum) permitted on either all or for each individual server;
c. Thresholds (such as threshold license limits) to log warnings by absolute number or by %;
d. Destinations to log warnings via a syslog server;
e. Simple Network Management Protocol (SNMP) trap destinations to log warnings by SNMP;
f. Preferences to weigh connections by administrative cost (referred to herein as “application sub-type”); and
g. Limits or thresholds by application sub-type (e.g., SQL server=application. Its sub-types are “MYSQL” and “MS-SQL”).

The following configuration parameters are examples only that will be used to explain operation of an embodiment of the invention to manage licensed connections to the servers 120-122:

Configuring the SW1 switch 114 at the block 202, such as via configuration settings 126 or other file(s) at the switches 114-118, can include the following example settings:

| Service | sqlserv | destination port (DP): 156 |
|---|---|---|
| Server | | sql.domain.org |
| VIP address | | 10.1.0.1 (VIP) |
| Real server | SQL1 | 10.1.0.2 |
| Real server | SQL2 | 10.1.0.3 |
| License total | | 50 |
| License limit warning | | 90% (or 45 licenses) |
| License log local | | ON |
| License log syslog | | 10.2.0.1 |

From the above, a total of 50 licenses have been paid for (with 25 licenses distributed to each of the servers 120 and 122), with a warning to be generated to the network operator (associated with the users' 102 network) if 90% of the licensed connections are currently taken, so as to advise the network operator of an impending or imminent over-capacity situation. The network operator can monitor all license logging on the SW1 switch 114 by accessing the syslog server 124 through a command line interface (CLI) such as telnet 10.2.0.1 or telnet sw1.domain.org, so as to view the data in the data repository 124. The network operator can also monitor all license logging with SNMP monitoring tools.

Continuing this example, the SW1 switch 114 detects (by monitoring TCP/IP packets in one embodiment) a user45's attempt at a block 204 to connect to sql.domain.org in order to use the sqlserv service. The SW1 switch 114 determines sql.domain.org (or its IP translation to 10.1.0.1) as a destination address (DA), and also determines port 156 as the DP. The SW1 switch 114 checks at the block 204 whether the DA and/or DP correspond to a defined service.

At a block 205, the SW1 switch 114 checks the TCP state in an embodiment. If the state is ACK or SYN/ACK, then the SW1 switch 114 updates the connection state at a block 206. If the state is SYN, then the flowchart 210 proceeds to a block 207. The procedure when the state is FIN at the block 205 (e.g., a current session has ended) will be described later below.

At the block 207, the SW1 switch 114 checks the license settings to determine if the license settings corresponding to the requested service are local or inherited from a parent. If inherited, then the SW1 switch 114 gets the parent license count at a block 208, and also increments the parent license count if available and then proceeds to a block 210 in FIG. 2B. If the license settings are local at the block 207, then the flowchart 200 proceeds to the block 210.

The SW1 switch 114 checks the license count and state at a block 210, and for purposes of this example sees 44 existing connections. Since 50 licensed connections are allocated (e.g., 45 connections are still below the limit of 50), the user45's connection is determined to be permitted at the block 210.

At a block 218, the user45's connection is logged at either or both the local license count or the syslog server 124. Since there are now 45 licensed connections, the warning limit of 45 (which is 90% of 50 as specified in the configuration settings above) has been reached. Therefore at the block 218, a warning message is provided to the system administrator to notify the system administrator that the 90% limit has been reached. An example syntax for such a message may be:
9:25 AM sw1.domain.org: service sqlserv threshold 90% reached with 45 of 50 licenses connected on real server sql2.domain.org (10.1.0.3).

The SW1 switch 114 maps the source address and source port (SA:SP) to sql2.domain.org internally, and forwards (or otherwise grants) the requested connection for the user45 at a block 212. If a load balancing mechanism is determined to be present at a block 214, then the user45 is connected to the appropriate server, based on whether the load balancing is determined remotely at a block 216 or locally at a block 219. In this example, the user45 is connected to the SQL2 server 122—it is assumed that the prior user (user44) was connected to the SQL1 server 120, and so the next user (user45) is connected to the SQL2 server 122—the loads are balanced in such a manner that each server 120 and 122 alternate connections (or “round robin”) for each incoming user—it is assumed for illustrative purposes only in this example that round robin is the load balancing method that is used—any suitable load balancing technique may be used.

If a load balancing mechanism is not present or unknown at the block 214, then the connection to the requested service is simply permitted. Individual sessions, whether load balanced or not, eventually finish at a block 220.

The flowchart 200 then proceeds from the block 220 back to the block 204 of FIG. 2A, where the SW1 switch 114 determines if additional users are requesting access—up to another 5 users can be accommodated in this example until the limit of 50 licensed connections is reached.

It is noted that if the threshold warning limit of 45 users had not been reached back at the block 210, then the flowchart 200 proceeds to the block 212 and onward as described above to detect additional connections. If no additional requests for connections are detected at the block 204, then the syslog server 124 and/or the local license count are updated as each existing user connections ends. More specifically in one embodiment, the TCP state is FIN at the block 205 when a current session ends. At a block 221, the SW1 switch 114 checks the license settings to determine if they are local or inherited. If local, then the number of connections and log are updated at a block 222. If inherited, the parent license count is decremented at a block 223 to account for the session that has just ended.

If additional users request connection at the block 204, then the process repeats as described above at the block 205 onward. As an example, assume that 4 additional users (user46-user50) request a connection. This number of users is still within the limit of 50 licensed connections as determined at the block 210, and so, the additional users are granted connection at the block 212 based on a load-balancing distribution between the servers 120 and 122, if a load balancing mechanism is implemented. However, the additional users are now above the license limit warning of 45 at the block 210, and therefore, the following example warning messages can be provided to the system administrator at the block 218:
9:26 AM sw1.domain.org: service sqlserv threshold 90% reached with 46 of 50 licenses connected on real server sql1.domain.org (10.1.0.2).
9:27 AM sw1.domain.org: service sqlserv threshold 90% reached with 47 of 50 licenses connected on real server sql2.domain.org (10.1.0.3).
9:27 AM sw1.domain.org: service sqlserv threshold 90% reached with 48 of 50 licenses connected on real server sql1.domain.org (10.1.0.2).
9:28 AM sw1.domain.org: service sqlserv threshold 90% reached with 49 of 50 licenses connected on real server sql2.domain.org (10.1.0.3).
9:29 AM sw1.domain.org: service sqlserv threshold 90% reached with 50 of 50 licenses connected on real server sql1.domain.org (10.1.0.2).
9:29 AM sw1.domain.org: service sqlserv license at limit with 50 of 50 licenses connected:
   25 licenses connected on real server sql1.domain.org (10.1.0.2)
   25 licenses connected on real server sql2.domain.org (10.1.0.3).

If an additional user (e.g., user51) is detected as attempting to connect to the service at 9:30 AM at the block 204, then the process described above repeats to process this request and to determine if the requested connection should be granted. Here, it is assumed that no users have disconnected since the user50 connected and before receipt of the request by the user51. At the block 210, the SW1 switch 114 determines that the license limit of 50 has been reached and that no additional connections are permitted or else the limit will be exceeded. The SW1 switch 114 logs a message to the local and/or syslog server 124 to indicate that access is denied at a block 224. An example syntax of this log message is:
9:30 AM sw1.domain.org: service sqlserv license at limit with 50 of 50 licenses connected:
   25 licenses connected on real server sql1.domain.org (10.1.0.2)
   25 licenses connected on real server sql2.domain.org (10.1.0.3)
9:30 AM user51 at <user51's IP source address> connection denied. License is at limit.
   25 licenses connected on real server sql1.domain.org (10.1.0.2)
   25 licenses connected on real server sql2.domain.org (10.1.0.3)

At the block 224, the SW1 switch 114 can also send a TCP state FIN communication to the user and/or application. At a block 226, the SW1 switch 114 can send a notification to the user51 to notify that user that access is denied. Such a notification can be sent via XML, HTML, or other via other suitable format or protocol. Then, the process repeats at the block 204 and onward

It is therefore evident from the above example that the system administrator and/or the network operator at the user-side can access the syslog server 124 to see that the license limit has been met, and further see the distribution of users across servers and over time. Additionally, these individuals can review the logs at any time in the future and run a report to check licensing. Moreover, because the distribution of connections via load balancing (such as via round robin) are logged and continuously updated in the log, the switches can use this log information to act as “gatekeeper” that can always determine the current load state of each server, and thereby effectively manage license compliance among the distributed servers.

It is understood that the examples depicted in FIGS. 1-2 are merely illustrative and not limiting. As evident to a person skilled in the art having the benefit of this disclosure, it is possible to provide other arrangements to manage licenses across multiple switches, multiple IP subnets, with different numbers of users on different servers, across different locations, across multiple users, and so on. Thus, in a network, licenses can be managed on one or more servers, switches, routers, or external devices for server applications on one or more servers or IP subnets, with or without respect to geographic location, network connectivity, bandwidth, or other criteria. TCP/IP applications are supported including, well-known TCP/IP applications on any operating system (e.g., Unix, Linux, Solaris, AIX, Mac OS, Windows, BSD, SCO, and the like).

Any standard or custom application can be supported by an embodiment of the licensing management system when there is a 1:1 correspondence of destination port number and the application. Since there are 65,535 available TCP/IP ports by Internet Assigned Numbers Authority (IANA) convention, one embodiment can support up to 65,535 applications or “services” as defined in the configuration.

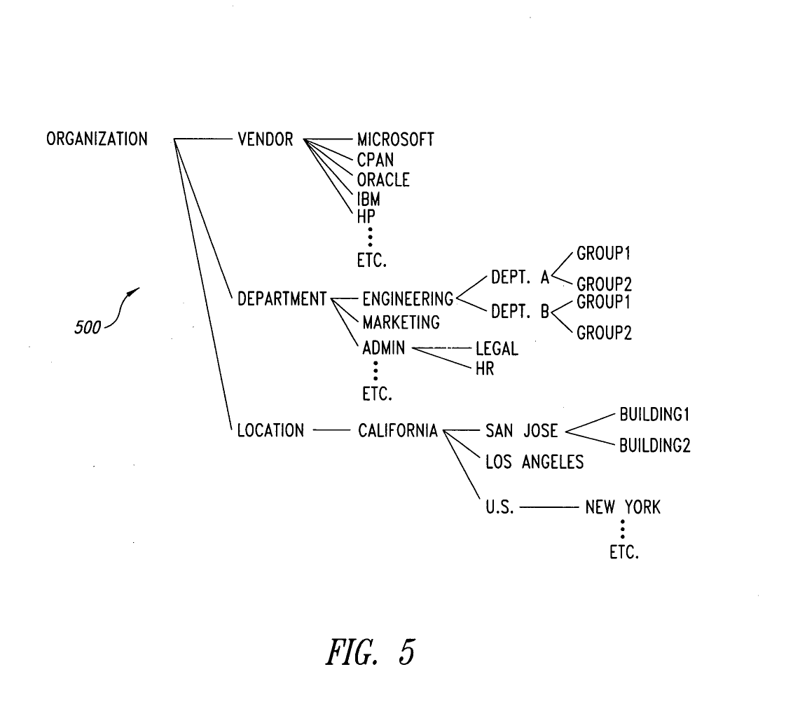

For each of these applications, there can be separately managed groups such that a company can choose to manage licenses enterprise-wide (1 group), by location for N locations (N groups), by workgroup, by project, by vendor of the application, by target operating system, or other organizational criteria. See FIG. 5 below for an example.

In the example described above, licensing connection decisions were made based at least in part on source and destination address information. In an embodiment, various types of layer 7 information can be used alternatively or in addition to this address information to determine the appropriate action to take (e.g., connect, deny, or otherwise process) for attempted connections. Such layer 7 information can include, but are not limited to, username, URL, domain name (or a username or of a URL), XML content, time of day, day of week, BGP information, and others.

The log data described above with respect to blocks 214, 218, and 224 can include one or more of the following:

1. Instances when limits or thresholds are set or changed;

2. Instances when limits or thresholds are met;

3. Instances when destinations for logging limits, thresholds, or other logging are either set or changed;

4. Logging by a local log on a device or system (including a computer), switch, router, or other device;

5. Logging via SNMP traps; and

6. Log information including: date, time, application name or type, application sub-type, instance or group ID, type of log message (e.g., warning, limit, threshold, change, set, etc.), debug details if enabled (including SA:SP, DA:DP, and layer 7 information), number of instances of any particular occurrence, source device DNS name, source device IP address, source device configuration (such as date and time of last change), and others.

Moreover, this logging may be enabled or disabled. The enabling/disabling may be performed globally or for each log destination, as well as for any type of logging (e.g., local, syslog, SNMP, and the like).

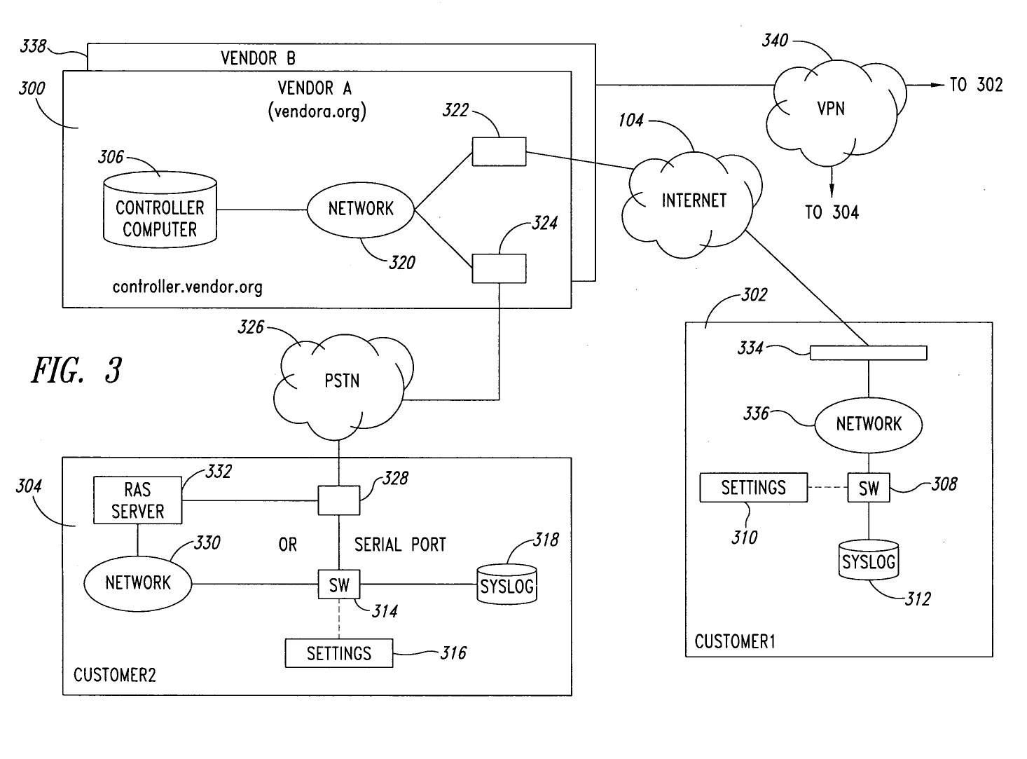

FIG. 3 illustrates example systems that may be used to remotely manage licenses in accordance with an embodiment of the invention. More particularly, FIG. 3 illustrates the manner in which a product vendor 300 (Vendor A) or other third party can remotely manage or monitor licenses that it has granted to a customer 302 (Customer1) and a customer 304 (Customer2). The vendor 300, as an illustrative example, manages its licenses to the customer 302 via Internet access, while the licenses to the customer 304 are managed via a modem access. It is appreciated that these two types of communication connections are merely examples. The connection communications may be performed using any sort of suitable network communication technique, and that remote control and access may be performed through a firewall, proxied, via Secure Shell (SSH), SNMP, CLI, or others.

The vendor 300 (at vendora.org, for example) includes a controller computer 306 (at controller.vendora.org, for example) that is used to remotely access, view, update, audit or otherwise manage license information at the customers 302 and 304. For example, the customer 302 has a switch 308 through which licensed connections to services are provided. The switch 308 includes configuration settings 310 and is coupled to a syslog server 312, in a manner similar to what is shown in FIG. 1. Analogously, the customer 304 has a switch 314 that includes its own configuration settings 316 and is coupled to a syslog server 318. The controller computer 306 of the vendor 300 can access the switches 308 and 314 to manage the license information in these switches' settings and syslog servers. For instance, the vendor 300 can verify license usage and compliance by viewing the data in the syslogs 312 or 318, or by viewing the configuration settings 310 or 316 to determine whether the appropriate number of licensed connections has been configured on the switches.

The vendor 300 also includes a network 320 and a network component 322 (such as a switch, router, server, etc.) through which the controller computer 306 can access the customer 302 via the Internet 104. For accessing the customer 304 via a modem connection, the vendor 300 includes a modem 324 that can communicate via a public switched telephone network (PSTN) 326 to a modem 328 at the customer 304. It is appreciated that any suitable technique may be used to allow the vendor 300 to remotely communicate with the customers 302 and 304. These include, but are not limited to, virtual private network (VPN), private carrier, dial-up, dial-back, Internet (such as through VPN, ACL, firewall, or open), direct, private dedicated line, and so forth.

With regards to the customer 304, the vendor 300 can telnet, use remote shell (such as SSH command), SNMP, or other means to signal the switch 314 via the modems 324 and 328, a remote access service (RAS) server 332, and a local network 330. Alternatively or in addition, the switch 314 can be accessed by way of a serial port connection between the modem 328 and the switch 314.

With regards to the customer 302, Internet access to the switch 308 can be provided by way of a secure firewall 334 and a local network 336. For example, if the source address SA is controller.vendora.org and the destination address is sw.customer1.org, then the firewall or an access control list (ACL) can be configured to allow secured access to a specific destination port of the switch 308, such as DP: 15615.

One or more additional vendors 338 (e.g., Vendor B) can also be communicatively coupled to the customers 302 and 304, such as via a VPN 340 or other communication connection, including those similar to ones used by the vendor 300. The vendor 338 can thus access the syslog servers or other data maintained by these customers, in order to monitor usage of their license(s). Therefore, license management via the systems shown in FIG. 3 can be used across multiple applications and/or across multiple vendors. In addition to the real-time and historical logging data maintained by the customers 302 and 304 for their own license management, such data can also be used to generate reports for archival and/or third party reporting, for example.

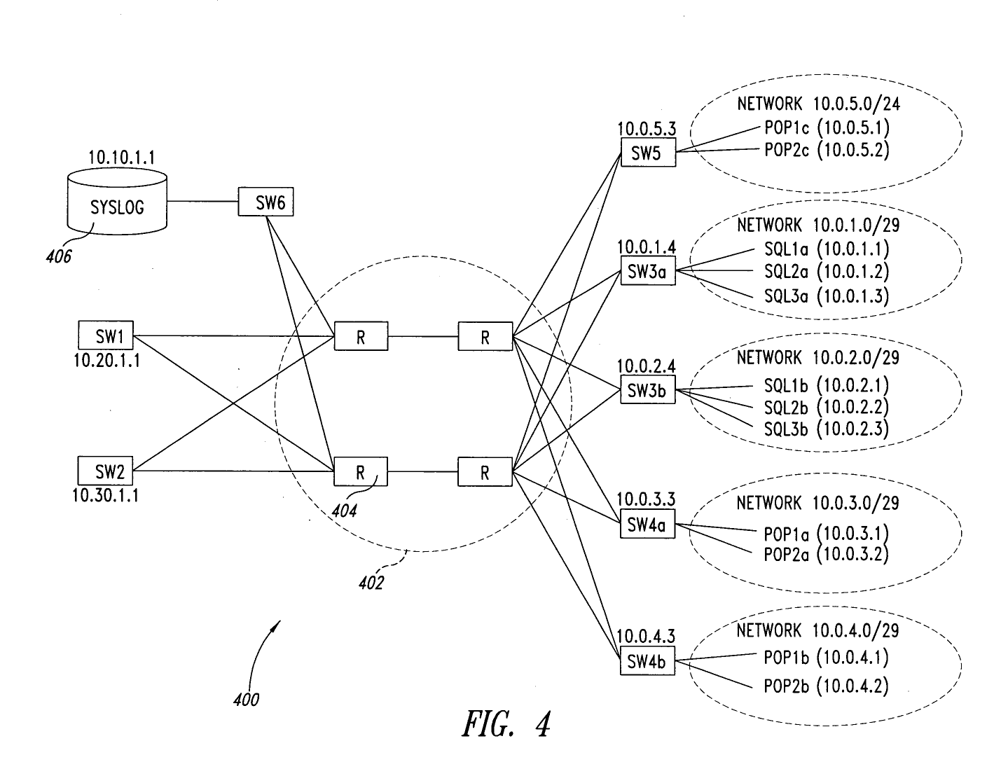

FIG. 4 illustrates an example hierarchical license management system 400 in accordance with an embodiment of the invention. In the system 400, a network 402 having a plurality of routers 404 are provided—the network 402 can be any type of backbone or internal network that can provide suitable network connectivity. A plurality of switches SW1, SW2, SW3a, SW3b, SW4a, SW4b, SW5, and SW6 is coupled to the routers 404, with the SW6 switch also being coupled to a syslog server 406. The switches SW3a, SW3b, SW4a, SW4b, and SW5 provide access to POP and SQL services in this example (with such services being present in the various example IP sub-networks), and it is appreciated that access to other types of services may be provided. Example network addresses for at least some of the components of the system 400 are also indicated in FIG. 4.

In an embodiment, the switches are arranged according to master/slave and parent/child relationships. Master/slave relationships are used to provide hot standby backups for configurations. Parent/child relationships are used to establish global policies (at parent devices) and control those policies on local networks (where the servers are) by inheriting the policies from parents. For instance, the SW1 and SW2 switches store the license policy or other license management settings. The SW1 switch is the master for the SQLSRV policy, while the SW2 switch is the slave for the SQLSRV policy. The SW1 switch is the slave for the POP3 policy, while the SW2 switch is the master for the POP3 policy. Some sample configuration settings are as follows:

For the SW1 switch:

| Service | sqlsrv | DP: 156 |
|---|---|---|
| Child | | sw3a.domain.org |
| Child | | sw3b.domain.org |
| VIP Address | | 10.20.1.2 |
| Method | | Round robin |
| Server | | 10.0.1.4 |
| Server | | 10.0.2.4 |
| Master | | Local |
| Slave | | sw2.domain.org |
| License Total | | 300 |
| License Limit Warning | | 290 |
| License Log | | Local |
| License Log Syslog | | 10.10.1.1 |
| Service | POP3 | DP: 110 |
| Master | sw2.domain.org | 10.30.1.1 |

For the SW2 switch:

| | | |
|---|---|---|
| Service | sqlsrv | DP: 156 |
| Master | | sw1.domain.org |
| Service | POP3 | DP: 110 |
| Child | | sw4a.domain.org |
| Child | | sw4b.domain.org |
| Server | | pop.domain.org |
| VIP Address | | 10.30.1.2 |
| Method | | Round Robin |
| Server | | 10.0.3.2 |
| Server | | 10.0.4.2 |
| Slave | | sw1.domain.org |
| License Total | | 400 |
| License Limit Warning | | 385 |
| License Log | | Local |
| License Log Syslog | | 10.10.1.1 |

For the above, round robin has been used as an illustrative load-balancing technique. Other techniques that may be used include, but are not limited to, least connections, weighted round robin, best response time, and so forth. The local switches can be configured as follows, for the switch SW3a for example:

| Service | sqlsrv | DP: 156 |
|---|---|---|
| Parent | | sw1.domain.org |
| VIP Address | | 10.0.1.4 |
| Real Server | | 10.0.1.1 |
| Real Server | | 10.0.1.2 |
| Method | | Least Connections |
| License Total | | Inherited |
| License Log | | Local |
| License Log Syslog | | 10.10.1.1 |

For the sake of brevity, the configuration settings for the other local switches SW3b-SW4b are not listed—each follow the general master/slave and parent/child relationship depicted above. Also in this example, adding another server farm to the SW5 switch can be accomplished by configuring the SW5 switch as a child (similar to the SW3a switch) and adding one line from the SW5 switch (at 10.0.5.3) to the POP3 service on the SW2 switch. The specific settings are inherited by the SW5 switch from its parent SW2 switch. Software technology available from the GSLB and SLB Serverlron™ line of products from Foundry Networks, Inc. of San Jose, Calif. can be used to operate the master/slave and parent/child relationship.

The system 400 of FIG. 4 can further include a security component or other authentication scheme to provide authentication for the various illustrated network resources that are arranged based on the master/slave and parent/child relationships. In one embodiment, a key-based system (such as a MD5 key exchange) can be used to authenticate peers.

It is evident from the various example systems illustrated and described above that license configuration settings may be reported to vendors, system administrators, network operators, or other entity having authorized access. License information that can be reported includes information on a local device, and/or on each and every logically dependent device (recursively down the organization trees depicted above).

Moreover, such reports can be run or generated for viewing locally, or saved to a storage location for later transfer (such as via FTP, syslog, http, XML, and so forth). Example formats for the reports are text, XML, html, and others, and can include state information (current number of sessions) for every license, for the current time, and for a current range of times (history). The reports may be generated on-demand or automatically based on a time interval (e.g., hourly, daily, every 5 minutes, etc.).

FIG. 5 is a diagram 500 that symbolically depicts organization of licenses in accordance with an embodiment of the invention. It is appreciated that the diagram 500 is merely one example of a license organization scheme and that any organization scheme is possible.

Licenses for an organization, enterprise, or other entity can be arranged according to vendor, department, location, and so forth. Each of these can further be sub-organized into subgroups as shown in FIG. 5. For instance, the engineering department has license allocations based on groups 1 and 2 in both departments A and B.

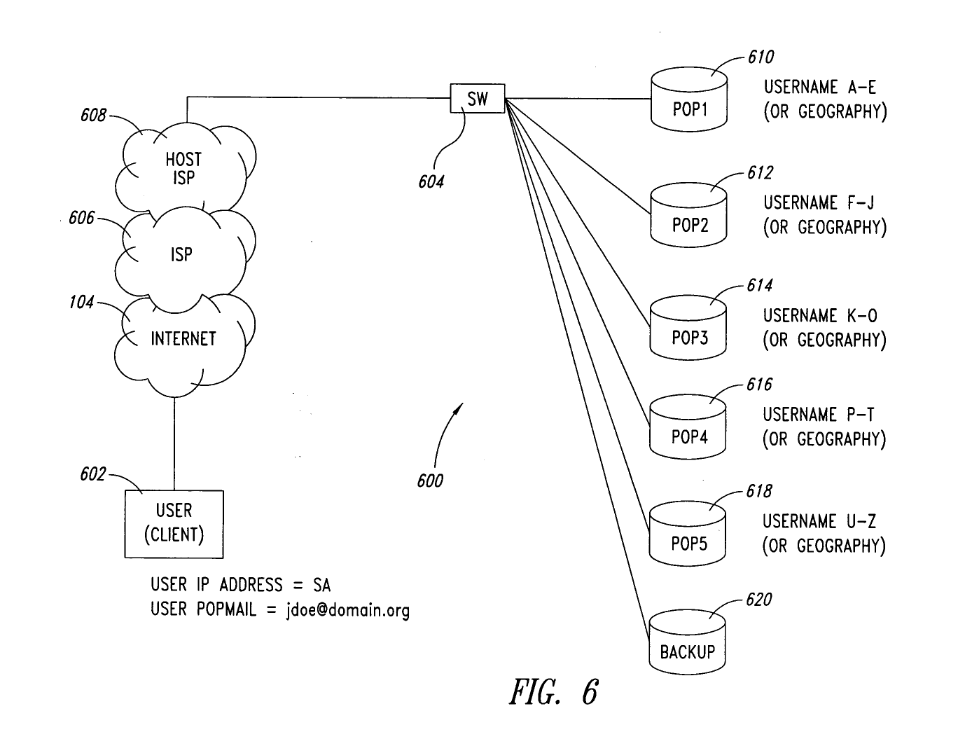

FIG. 6 shows a system 600 to balance mail (such as POP mail for example) in accordance with an embodiment of the invention. In particular and in a manner similar to some features of the licensing management systems previously described, the system 600 uses session-based and username information (layer 5 through layer 7 information, including geographical information), in addition to port-based mapping information (layer 4) to load balance electronic mail among a plurality of servers. For purposes of explanation, the system 600 will be described in the context of POP mail—it is appreciated that the mail distribution techniques can be applied to other types of mail protocols.

In the system 600, a user or client 602 (having a username jdoe@domain.org in this example) can connect to a switch 604, via the Internet 104, an Internet service provider (ISP) 606, and a host ISP 608. For simplicity, other network components (such as additional switches and routers) are not shown or described. A plurality of POP mail servers 610-618 are coupled to and sit behind the switch 604.

In an embodiment, each of the servers 610-618 are configured for and assigned to a certain set of usernames (such as alphabetical allocations for each server), rather than having each and every server having to access one or more back-end data stores that has all of the information for all users. A back-up server 620 can be provided if any of the servers 610-618 fail, with the back-up server 620 having the configuration information for all usernames or at least some of the usernames present at the other servers 610-618. The assignment of users to each server by username can be performed using any sort of suitable criteria that best manages the load distribution, taking into account factors such as certain letters that are used more frequently in usernames than other letters (e.g., the non-uniform distribution of username letters in the alphabet), usernames and/or domains that are known to involve relatively higher traffic volume, and so forth.

As depicted in FIG. 6, the allocation of usernames can be based on alphabetical letters. Alternatively or in addition, geographical server distribution can be provided, so that users are distributed physically or electronically their home network location. Hashing algorithms or parsing techniques can be used to obtain the appropriate username or geographical information from the layer 7 information (or information from other layers).

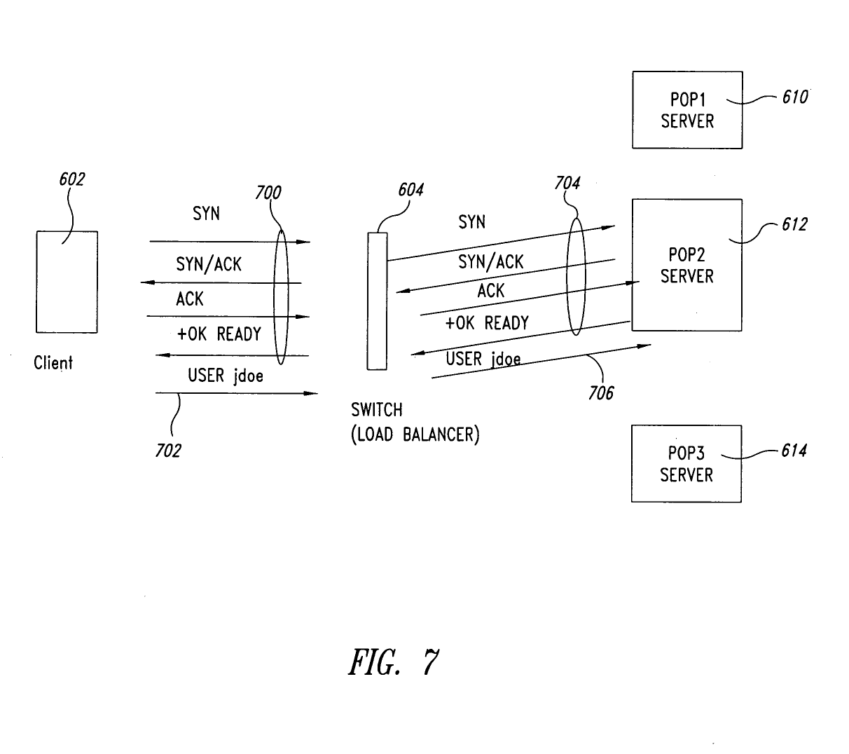

FIG. 7 diagrammatically illustrates operation of the POP mail balancing in accordance with an embodiment of the invention. At 700, the client 702 (username jdoe) performs a SYN/ACK handshake with the switch 604, which is acting as a proxy and load balancer for the POP mail servers 610-618. Upon successful completion of this handshake, the client 602 sends the username jdoe to the switch 604 at 702, or sends' some other information from which the username can be identified, including layer 7 information.

The switch 604 then applies a hashing algorithm or other technique to obtain the jdoe username and then to determine which server 610-618 is configured for that user name. This determination can be performed using a number of techniques, including use of look-up tables or other mechanism to match the username to one of the servers 610-618.

Upon determination that the user jdoe should be connected to the server 612 (which is configured for usernames F-J), the switch 604 performs a SYN/ACK handshake with the server 612 to establish a connection with this real server. Once the connection between the server 612 and the switch 604 is established, the communication splice for user jdoe is established at 706, and all further communications are passed on until termination signaled by the TCP state FIN.

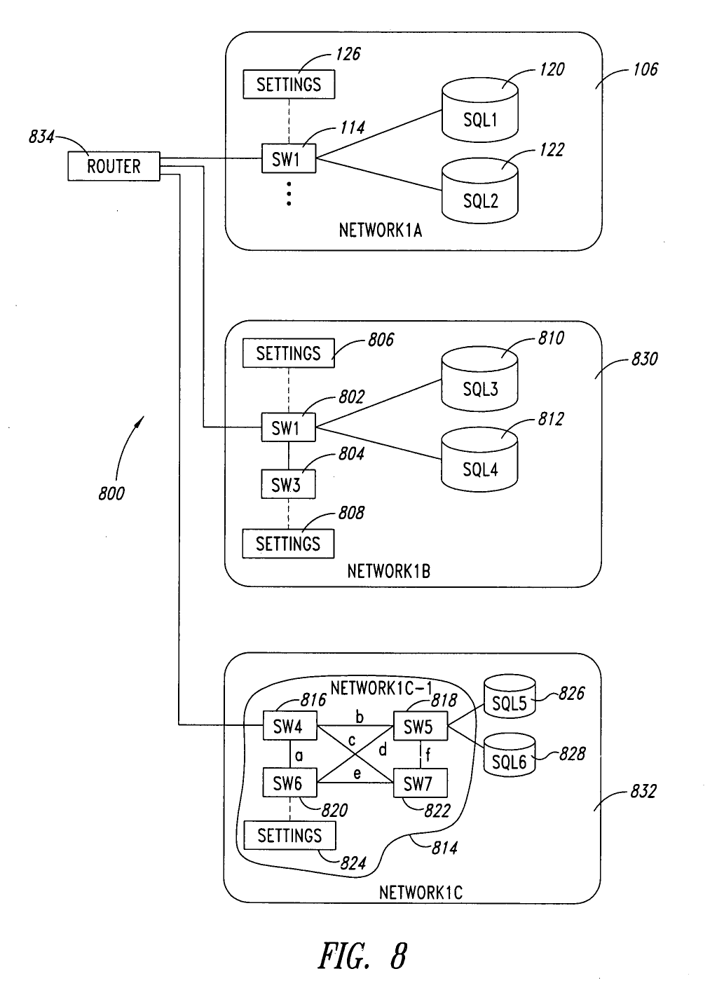

FIG. 8 shows another system 800 in accordance with another embodiment of the invention. The system 800 illustrates that license management may be performed separately from, remotely from, or independently of any load balancing. FIG. 4 shows an example of one type of remote load balancing technique, while FIGS. 1 and 6 show examples of local load balancing techniques—any of a number of suitable load balancing techniques may be implemented. For purposes of example and comparison only, the network 106 (Network1) of FIG. 1, where load balancing is performed locally along with license management, is also depicted in FIG. 8.

A network 830 (Network1B) shows an SW1 switch 802 to perform Ethernet switching between SQL servers 810 and 812. A separate SW3 switch 804 runs the license management software to manage the licenses on the servers 810 and 812. The switches 802 and 804 can each have their own set of configuration settings 806 and 808, respectively, with the settings 808 having license parameter settings.

A network 832 (Network1C) shows a few combinations of separate Ethernet switching, load balancing, and license man agement components. A network 814 (Network1C-1) within the Network1C shows one combination of many possible combinations and permutations of interconnecting switches 816-822 (shown as SW4, SW5, SW6, and SW7 switches), such that any one or more of interconnections a-f could be use. Any of the switches 816-822 can have configuration settings 824, which can comprise switching configurations, load balancing configurations, licensing parameter settings, and others or combinations thereof. For instance, if the SW7 switch 822 performs license management, the license management can be applied to SQL servers 826 and 828.

The networks 106, 830, and 832 can be coupled to one or more routers 834, which can include the router 112 of FIG. 1. Ethernet switching, license management, and load balancing can all be combined or separated in any suitable way, such as via the following examples:
SW4=Ethernet Switch
SW5=Ethernet Switch
SW6=Load Balancer
SW7 License Management
Or
SW11=Ethernet Switch, Load Balancer, And License Management
Or
SW4=Ethernet Switch
SW5=Load Balancer And License Management
Or
SW4=Load Balancer
SW5=License Management And Ethernet Switch
Etc.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

For example, various examples above have been described with reference to specific network addresses, port assignments, message syntax, address formats, and so forth. It is appreciated that these are merely examples and that embodiments can be implemented with any type of suitable syntax, assignment, format, and so forth.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
receiving a request to access a network resource accessible through each of a plurality of servers, wherein licenses to access said network resource are distributed to each respective said servers and wherein a total of said licenses distributed to said servers corresponds to a maximum limit of allowed licensed connections to said network resource;
determining whether granting the requested access to the network resource provides a number of licensed connections equal to or less than said maximum limit;
granting the requested access to the network resource if it is determined that the granting of the requested access provides said number of licensed connections equal to or less than said maximum limit;
load balancing according to license availability by directing said granted requested access to one of said servers having at least one of its said respective licenses available for said requested access; and
providing a warning message if a threshold limit, of a number of licensed connections less than said maximum limit of licensed connections, is reached.

2. The method of claim 1 wherein said network resource includes an application available from each of said servers.

3. (canceled)

4. The method of claim 1 wherein said servers include mail servers and wherein said licenses distributed to said servers include licenses allocated to a plurality of said mail servers based on usernames assigned to said mail servers.

5. (canceled)

6. The method of claim 1 wherein said servers include mail servers and wherein said licenses distributed to said servers include licenses allocated to said mail servers based on geographic information associated with users that request access to the network resource.

7. The method of claim 1, further comprising keeping at least one of a local log or syslog to track information associated with licensed connections to the network resource.

8. The method of claim 7, further comprising providing third-party access to at least one of the local log or syslog to allow licenses associated with the tracked information stored therein to be remotely managed or monitored.

9. (canceled)

10. The method of claim 1 wherein associated maximum limits of allowed licensed connections, of a plurality of network resources, are arranged according to a parent/child arrangement.

11-36. (canceled)

37. An apparatus, comprising:
a network device adapted to load balance traffic amongst a plurality of servers according to a number of paid permitted connections to a network resource available through said plurality of servers,
wherein said network device is further adapted to provide a warning if a threshold limit, of a number of paid permitted connections less than a maximum limit of paid permitted connections, is reached.

38. The apparatus of claim 37 wherein said network device is a switch adapted to direct a request to access said network resource to one of said servers, which are communicatively coupled to said switch.

39. The apparatus of claim 37 wherein said plurality of servers include email servers.

40. The apparatus of claim 37, further comprising a data repository, included in said network device and accessible by said network device, to store log information usable by said network device to determine usage of, and compliance with an agreement pertaining to, said paid permitted connections.

41. (canceled)

42. An article of manufacture, comprising:
a storage medium storing instructions that are executable by a network device to:
determine a number of paid permitted connections to at least one network resource accessible through each of a plurality of servers, wherein said number of paid permitted connections to said at least one network resource is distributed amongst said servers;
load balance traffic amongst said plurality of servers according to said number of paid permitted connections; and
provide a warning if a threshold limit, of a number of paid permitted connections less than a maximum limit of paid permitted connections, is reached.

43. The article of manufacture of claim 42 wherein said plurality of servers include an email server.

44. The article of manufacture of claim 42 wherein said instructions executable by said network device to determine includes instructions executable by said network device to:
access a data repository adapted to store log information, including data that specifies said number of paid permitted connections; and
use said log information to determine usage of, and compliance with an agreement pertaining to, said paid permitted connections.

45.-47. (canceled)

48. An apparatus, comprising:
a network device adapted to load balance traffic amongst a plurality of servers according to a number of paid permitted connections to a network resource available through said plurality of servers,
wherein said network device is further adapted to provide a warning if a threshold limit, of a number of paid permitted connections less than a maximum limit of paid permitted connections, is reached, and
wherein said servers include mail servers and wherein said paid permitted connections available through said plurality of servers include licenses allocated to said mail servers based on usernames assigned to said mail servers.

49. The apparatus of claim 48, further comprising a data repository, included in said network device and accessible by said network device, to store log information usable by said network device to determine usage of, and compliance with an agreement pertaining to, said paid permitted connections.

50. The apparatus of claim 48 wherein said paid permitted connections available through said plurality of servers further include licenses allocated to said mail servers based on geographic information associated with users that request access to the network resource.
